(19) United States
(12) Patent Application Publication
(10) Pub. No.: US 2004/0260951 A1
(43) Pub. Date: Dec. 23, 2004

(54) Method and Packet Data Service Node (PDSN) for Quality of Service (QoS) mapping

(76) Inventor: Lila Madour, Kirkland (CA)

Correspondence Address: ALEX NICOLAESCU, Ericsson Canada Inc., Patent Department (LMC/M/P), 8400 Decarie Blvd., Town Mount Royal, QC, H4P 2N2, CA

(21) Appl. No.: 10/823,726

(22) Filed: Apr. 14, 2004

Related U.S. Application Data
(60) Provisional application No. 60/462,685, filed on Apr. 14, 2003.

(51) Int. Cl. H04L 9/00

(52) U.S. Cl. 713/201

(57) ABSTRACT

A method and Packet Data Service Node (PDSN) for using traffic classes to define a Quality of Service (QoS) of a data session. The PDSN receives from an Authentication, Authorization, and Accounting (AAA) server a message comprising a QoS traffic class, and translates the QoS traffic class into at least one CDMA2000 QoS attribute using a mapping table storing correspondence between QoS traffic classes and CDMA2000 QoS attributes. The PDSN establishes a data session for the subscriber using the CDMA2000 QoS attribute. For example, a Mobile Node (MN) may request establishment of an auxiliary service instance with a requested CDMA2000 QoS attribute and, upon receipt of the request, the PDSN determines if the requested CDMA2000 QoS attribute is allowed using the CDMA2000 QoS attribute and, if allowed, sets-up the auxiliary service instance with a QoS that corresponds to the requested CDMA2000 QoS attribute.

### PRIORITY STATEMENT UNDER 35 U.S.C. S.119(e) & 37 C.F.R. S.1.78

This non-provisional patent application claims priority based upon the prior U.S. provisional patent application entitled “EFFECTIVE METHOD OF USING UMTS TRAFFIC CLASSES IN A CDMA2000 NETWORK”, application No. 60/462,685, filed Apr. 14, 2003, in the name of Lila MADOUR.

### BACKGROUND OF THE INVENTION

1. Field of the Invention

The present invention relates to the provision of Quality of Service (QoS) information in a Code-Division Multiple Access (CDMA2000) network.

2. Description of the Related Art

CDMA2000, also known as IMT-CDMA Multi-Carrier or IS-95, is a Code-Division Multiple Access (CDMA) version of the IMT-2000 standard developed by the International Telecommunication Union (ITU). The CDMA2000 standard is a third-generation (3G) mobile wireless technology allowing mobile nodes (e.g. mobile stations, wireless PDAs, etc) to access IP-based high-speed voice and data traffic over the CDMA-based cellular network. CDMA2000 can support mobile data communications at speeds ranging from 144 Kbps to 2 Mbps.

In order to fully recognize the advantages of the present invention, a short description of some technical concepts associated with CDMA2000 IP-based cellular telecommunications networks is required. A typical CDMA2000 network comprises a number of nodes including a plurality of Mobile Nodes (MNs), a plurality of Base Stations (BSs), one or more Packet Control Functions (PCFs) and one or more Packet Data Serving Nodes (PDSNs), or their equivalent. The BSs may be connected to the PCF, which is an entity in the CDMA2000 Radio Access Network (RAN) that controls the transmission of data packets between the BSs and the PDSN. The PCF is in turn connected with the PDSN.

In a CDMA2000 network, the PDSN provides access to the Internet, intranets and applications servers for MNs utilizing the CDMA2000 RAN. Acting as an access gateway, the PDSN provides simple IP and mobile IP access, foreign agent support, and packet transport for virtual private networking. It may also act as a client for an Authorization, Authentication, and Accounting server (AAA) and provides the MNs with a gateway to the IP network.

The AAA server of a CDMA2000 network intelligently controls access to network resources, enforces policies, audits the usage, and provides the information necessary to bill for the services accessed by the MNs. These combined processes are essential for effective network management and security.

In some situations, an MS may instantiate a generic packet data service at the beginning of a packet data session established with a serving PDSN, and may use the service as a primary connection, also herein called primary service instance with the serving PDSN. Typically, when the requested service requires a higher bandwidth, or a better Quality of Service (QoS) than the one provided solely by the primary service instance, the MS may request the establishment of one or more additional service instances, herein called auxiliary service instances or connections, in order to fulfill the need for the greater bandwidth or QoS. Such situations may occur, for example, when requesting a multimedia session, a video conference call, a file download or upload, or with any other real-time application. For example, in current CDMA2000 networks, 3GPP2 standard recommendation specifies that up to six (6) different service instances may be established for exchanging data over a packet data session between a PDSN and a serviced MS, as per the need of the application launched on the MS. Two (2) more service instances may also be reserved for control signalling between the same PDSN and MS. Each one of the established service instances is typically identified within the PDSN and the MS by a Service Reference Identifier (SRID). The allocation of the appropriate number of service instances is performed by the PDSN during the call set-up, as per the request of the MS, or alternatively during an ongoing data call.

In a CDMA2000 network, an end-to-end QoS model has been defined for insuring the provision of an adequate quality of connection. Reference is now made to FIG. 1 (Prior Art) that is a high level functional diagram illustrating the CDMA2000 end-to-end QoS architecture model identifying different QoS segments of an end-to-end QoS path of a CDMA2000 network. In FIG. 1, different QoS mechanisms may be applied on each identified traffic segment to satisfy QoS delivery of data packets through the segments for ultimately satisfying overall end-to-end QoS delivery. Shown in FIG. 1 are exemplary CDMA2000 nodes, such as a Terminal Equipment (TE) 102 and a Mobile Terminal (MT) 104 that compose a Mobile Node (MN) 106 receiving CDMA2000 wireless service via a RAN 108 from a CDMA2000 core network comprising at least a PDSN 110, a Home Agent (HA) 112, and a Border Router (BR 114) that may be deployed at the border of the core network with a neighbouring (or peer) network in a different administrative domain. The BR 114 may enforce the service level agreements between its network and the peer network. The MN 106 is also in communication with a Corresponding Node (CN) 116, that may comprise, for example, another MN or a server.

The end-to-end QoS Service 120 is defined as the application layer QoS between the end hosts (MN 106 and CN 116), and identifies the QoS requirements, for example via SIP/SDP (Session Initiation Protocol/Session Description Protocol). The QoS requirements from the application layer are mapped down to create a network layer session. The MT 104 may then establish a link layer connection suitable for support of the network layer session. The QoS parameters received from the application layer are mapped to the corresponding IP layer signaling parameters as well as the link layer parameters.

In the end-to-end QoS scenario shown in FIG. 1, the IP QoS Service 122 encompasses an IP QoS service at the local and remote access networks and an IP QoS service through the backbone IP network. Any IETF (Internet Engineering Task Force) defined IP QoS service may be used for the different segments 130-142 of the end-to-end QoS service 120. The entities that support the IP QoS service act according to the IETF specifications for int-serv, int-serv/diff-serv (Integrated Services and Differentiated Services) or other allowed inter-working method.

The CDMA2000 bearer Service 130 is the bearer service between the MN 106 and the PDSN 110. It consists of the radio access bearer service 132 and the R-P bearer service 134. It includes a main connection where PPP (Point-to-Point Protocol) control traffic is carried and other auxiliary connections with varying QoS attributes. The CDMA2000 radio access bearer service 132 and their associated QoS attributes are defined in “Data Service Options for Spread Spectrum Systems C.S0017-0-2”, herein included by reference, which includes both the assured mode and non-assured mode QoS parameters, while the R-P Bearer service 134 is defined between the RAN 108 (that includes the BSC, and the PCF, not shown) and the PDSN 110. The RP bearer service 134 is provided by A8-A11 interfaces that need to be enhanced to signal assured mode QoS attributes to the PDSN 110.

The external bearer service 136 is provided by an external network, e.g. an IP core network that is not owned and operated by the wireless service provider.

The core network bearer service 138 of the CDMA2000 wireless IP network 100 provides bearer service the between PDSN 110 and the BR 114. It may be based on Diffserv (IETF defined Differential Services) and/or MPLS (Multi Protocol Label Switching).

The CDMA2000 radio transport service 140 is provided by the CDMA2000 physical layer that is categorized by QoS traffic classes and attributes based on stringent requirements of the physical radio channels (FCH, DCCH, SCH, etc). The MAC/Multiplex sub-layer has to map the radio bearer QoS attributes (logical channel) onto the physical channel QoS parameters. The radio transport layer service is concerned with the physical radio channel payload data units produced and consumed by the CDMA2000 radio bearer service plus any signaling associated with those radio channels, such as for example the common channel signaling, and call control messages and OAM.

Finally, the R-P transport service 142 is provided by the R-P transport network to guarantee delivery of the R-P bearer services within their specified QoS limits. The R-P network is typically a non-Diffserv network.

The CDMA2000 bearer service 130 comprises several management functions in the control plane, which are summarized hereinbelow:

The translation function (optional) converts between the internal service primitives for the CbMA2000 bearer service 132 control and the various protocols for service control of interfacing external networks. The translation includes converting between CDMA2000 bearer service attributes and QoS attributes of the external networks service control protocol (e.g. between IETF TSPEC and CDMA2000 QoS attributes);

The admission/capability control function maintains information about all available resources in the PDSN 110 and about all resources allocated to the CDMA2000 bearer services. This function checks also the capability of the PDSN 110 to provide the requested service, i.e. whether the specific service is implemented and not blocked for administrative reasons; and

The subscription control function verifies the administrative rights of the CDMA2000 bearer service user to use the requested traffic class with the specified QoS attributes.

The CDMA2000 bearer service 130 also comprises several management functions in the user plane, which are also summarized hereinbelow. These functions insure the provision of the QoS negotiated for a CDMA2000 bearer service. Depending on the capabilities of the service node, the type of service and application, the following functions may be applied:

The classification/filtering function, which function is to classify data packets based on a packet classifier. A packet classifier includes IP/TCP or IP/UDP header fields or a wildcard. IP header fields include IP address, port number, etc. Once the packets are classified according to the packet classifier, each class will be treated according to traffic conditioning schemes; and

The traffic conditioning provides conformity between the negotiated QoS for a service and the data unit traffic. Traffic conditioning is performed by a number of functions, such as metering, policing (dropping or re-marking), and traffic shaping.

In order to insure the appropriate QoS in a CDMA2000 network, there have been defined a series of CDMA2000 QoS Attributes that describe the characteristics of a requesting application, as follows:

The forward/reverse Link priority attribute: the priority is the user's priority associated with assured mode packet data service;

The forward/reverse minimum user data rate attribute: indicates the minimum bandwidth required for the application;

The forward/reverse data loss rate attribute: if RLP (Radio Link Protocol) does not use its retransmission mechanism, data loss rate is defined as being numerically equal to the Frame Error Rate. If RLP uses its retransmission mechanism, data loss rate is defined as the ratio of the number of lost data octets to the number of transmitted data octets, measured above RLP;

The forward/reverse link maximum delay attribute: maximum delay is defined as the amount of time user data can be held in a transmit queue (i.e., from the moment it is submitted to RLP for transmission until its actual transmission on a physical channel); the user data may be discarded if the maximum delay restriction is not met.

Recently, it has been introduced in CDMA2000 specifications the use QoS traffic classes, which are another, different, way of defining and insuring QoS then the traditional CDMA2000 QoS attributes. The QoS traffic classes shall now be supported by CDMA2000 networks for defining the required QoS for a given CDMA2000 session. QoS mechanisms that are defined from now on in CDMA2000 cellular networks must be capable to support all the defined traffic classes. Traffic class define the importance assigned to data traffic as well as typical traffic characteristics, and can be set by the user or defined in the subscription. Traffic class attributes implicitly set the allowed value ranges (e.g. if strict delay and low BER are required, it is up to traffic class to define what is reachable, i.e. what is an allowed combination). Four traffic classes attributes are defined, as follows:

The background attribute (non-interactive, non-real-time) is used for delay-insensitive applications. Examples of such applications include FTP and other types of bulk downloads;

The interactive attribute (interactive, non-real-time) is used for applications for which the user enters a request and must wait for a response, but which are not strictly real-time. Examples include web browsing, instant messaging, telnet, SSH, and news;

The streaming attribute (non-interactive, real-time) is used for applications that are not sensitive to round-trip latency, but must preserve strict inter-packet and intra-flow timing characteristics. Examples include streaming audio and video; and

The conversational attribute (interactive, real-time) is used for applications that are sensitive to round-trip latency and must preserve strict inter-packet and intra-flow timing characteristics. Examples of such applications include live voice and video conferencing.

Table 1 summarizes the description of the use of CDMA2000 traffic classes:

TABLE 1
CDMA2000 Traffic Classes

| Traffic | | | | |
|---|---|---|---|---|
| Class | Conversational | Streaming | Interactive | Background |
| Attributes | Class | Class | Class | Class |
| Fundamental | Preserves time | Preserves time | Requests | Destination is not |
| characteristics | relation (variation) | relation (variation) | response pattern | expecting the data |
| | between information | between information | Preserves payload | within a certain |
| | entities of the stream | entities of the stream | content | time |
| | Conversational | | | Preserves |
| | pattern (stringent and | | | payload content |
| | low delay) | | | |
| Example of | voice; | streaming video; | Web browsing; | background |
| application | | | | email download; |

However, although current CDMA2000 specifications requirements S.P0035 identify as optional the use of QoS traffic classes in CDMA2000 networks, the implementation and the details of the signalling was not specified by the standard.

Therefore, there is a need for a clear specification defining the exact call scenario for using QoS traffic classes in CDMA2000 cellular networks.

Although there is no prior art solution as the one proposed hereinafter for solving the above-mentioned deficiency, the U.S. patent application Publication No. 2002/0093936 bears some relation with the field of the present invention. This publication teaches a UMTS (Universal Mobile Telecommunications. System) core network that supports the negotiation of a symmetric traffic classes with a mobile station, or user equipment. A new QoS information element is defined to negotiate for a symmetric traffic classes. This publication properly illustrates that traffic classes were originally designed for use within UMTS networks.

Since the adoption of traffic classes for use also in CDMA 2000 networks, there was a need for an appropriate specification on how the QoS traffic classes, originally designed only for UMTS networks, could be used in CDMA2000 networks that have historically employed CDMA 2000 QoS attributes for defining and insuring the proper QoS for data sessions.

Accordingly, it should be readily appreciated that it would be advantageous to have a method and system for effectively and jointly employing CDMA2000 QoS attributes and traffic classes for QoS provision in CDMA2000 networks. The present invention provides such a solution.

### SUMMARY OF THE INVENTION

In one aspect, the present invention is a method for insuring Quality of Service (QoS) for a data session in a CDMA200 network, the method comprising the steps of:

a) receiving a message from an Authentication, Authorization, and Accounting (AAA) server, the message comprising a QoS traffic class relative to a subscriber;

b) mapping the QoS traffic class to at least one CDMA2000 QoS attribute; and

c) using the at least one CDMA2000 QoS attribute for establishing the data session for the subscriber.

In another aspect, the present invention is a Packet Data Service Node (PDSN) for use in a CDMA2000 network, the PDSN comprising:

a mapping table storing a correspondence between QoS traffic classes and CDMA2000 QoS attributes;

a User Profile Interface capable of receiving a message from an Authentication, Authorization, and Accounting (AAA) server, the message comprising a QoS traffic class relative to a subscriber; and

a Resources Management Logic that maps the QoS traffic class to at least one CDMA2000 QoS attribute using information from the mapping table, and that uses the at least one CDMA2000 QoS attribute for establishing a data session for a subscriber.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is an exemplary high-level functional diagram illustrating a CDMA2000 end-to-end QoS architecture model identifying different QoS segments of an end-to-end QoS path;

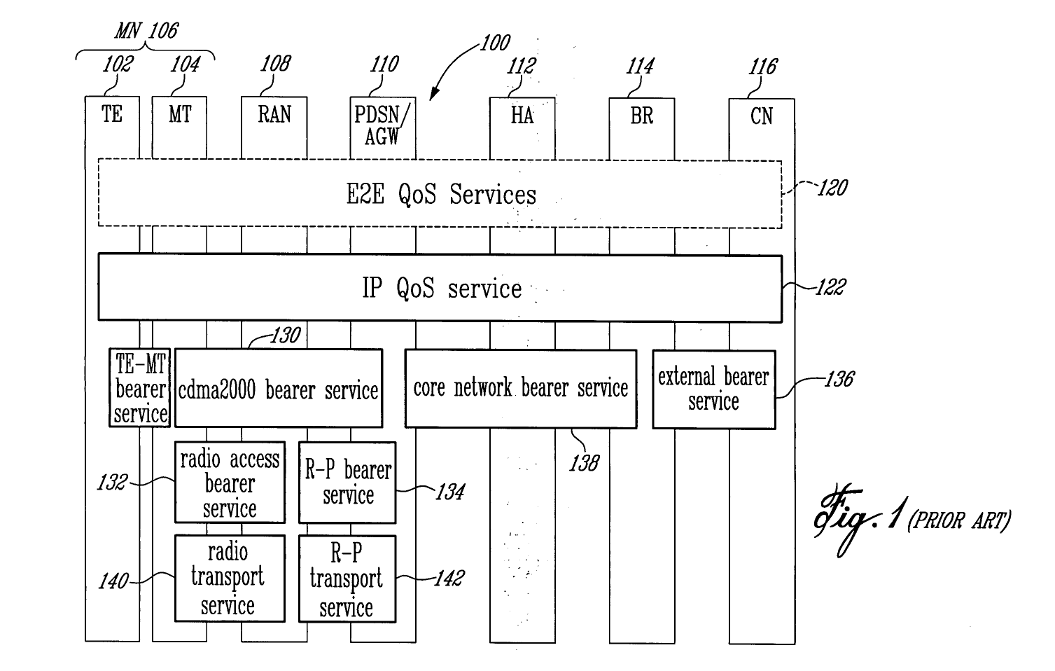

FIG. 2 is is an exemplary nodal operation and signal flow diagram of the preferred embodiment of the present invention related to the use of QoS traffic classes in a CDMA2000 cellular network;

FIG. 3 is an exemplary mapping table between QoS traffic classes and CDMA2000 QoS attributes according to the preferred embodiment of the invention; and

FIG. 4 is an exemplary high-level block diagram of a PDSN implementing the preferred embodiment of the invention.

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention provides a method and a Packet Data Service Node (PDSN) for using QoS traffic classes for insuring the proper QoS for a data session in a CDMA2000 network. In particular, the method and PDSN of the present invention can map the traffic classes specifying the QoS of a given user subscription into CDMA2000 QoS attributes that need to be enforced for the user data session.

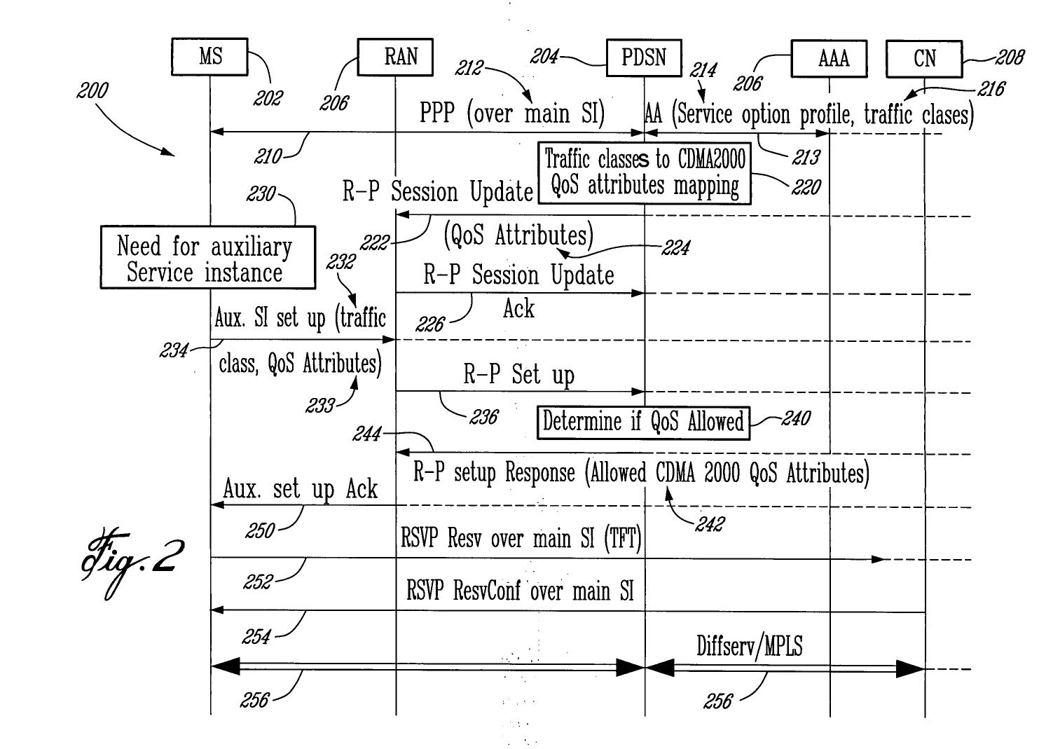

Reference is now made to FIG. 2, which is an exemplary nodal operation and signal flow diagram of the preferred embodiment of the present invention related to the use of traffic classes in a CDMA 2000 cellular network 200. Also shown in FIG. 2 is, first, a Mobile Station (MS) 202 (also called herein a Mobile Node, or MN) which is provided CDMA 2000 wireless service from a serving PDSN 204 over a Radio Access Network (RAN) 206. The PDSN 204 also connects to a AAA server 206 that performs authorization, accounting, and authentication for the CDMA2000 network 200. Finally, also shown in. FIG. 2 is a Corresponding Node (CN) 208 that is connected through a data session with the MS 202.

In action 210, the MS 202 first establishes a Point-to-Point Protocol (PPP) data session 212 or optionally a Mobile IP Session (not shown in the message flow) with the PDSN 204. The PDSN 204 performs authentication and authorization for the user by contacting the AAA server 206. In action 213, the AAA server 206 returns to the PDSN 204 a QoS user profile 214, which comprises a service option profile 214 and the allowed traffic classes 216 for the data session.

In action 220, a mapping is performed by the PDSN 204 between the received traffic classes 216 allowed for the data session and the CDMA2000 QoS attributes. This may be needed since the QoS request must be propagated to the RAN 206 for enforcement, and since the RAN 206 needs the information in terms of CDMA2000 QoS attributes, and not in the terms of QoS traffic classes.

If a default QoS traffic class is assigned for the main service instance, or if CDMA2000 QoS attributes are also received from the AAA server 206 in the action 213 (attributes not shown), the PDSN 204 may also determine based on its local policy and capabilities the CDMA2000 QoS attributes associated to that QoS traffic class.

Once the PDSN 204 determines which CDMA2000 QoS attributes best correspond to the requested traffic classes 216, it sends to the RAN 206 the determined CDMA2000 QoS attributes 224 which result from the mapping 220, action 222.

The RAN 206 sends an acknowledgement message 226 back to the PDSN 204 to acknowledge receipt of the CDMA2000 QoS attributes 224 for the main service instance. Actions 222 and 226 are optional and typically only needed if CDMA2000 QoS attributes are assigned to the background traffic class for the main service instance.

In action 230, the MS 202 determines that it requires at least one auxiliary service instance to carry data traffic for an application with different QoS needs. The MS 202 includes the required CDMA2000 QoS attributes 232 for the auxiliary service instance and also, optionally, the corresponding traffic class for the application 233, e.g. Streaming, in a request message 234 for setting up the auxiliary service instance. The RAN 206 receives the request message 234, and requests the establishment of an A10 connection, action 236, and forwards the requested CDMA2000 QoS attributes 232 and optionally the requested traffic classes 233 received in message 236 to the PDSN 204.

The PDSN 204 determines if the requested CDMA2000 QoS attributes 232 (and/or the QoS traffic classes 233) is allowed for the user based on the user profile containing the allowed traffic classes 216 received from the AAA 206 in action 213, action 240. If allowed, the PDSN 204 further determines based on the local policy and capabilities the CDMA2000 QoS attributes 242 it returns to the RAN 206 in action 244. The PDSN 204 sends a response back to the RAN 206 that contains the allowed CDMA2000 QoS attributes 242, which may be the ones (233) requested by the MS 202 in action 234, or new ones allowed by the PDSN 204 on the basis of its local policy, and capabilities.

The RAN 206 uses its local resource management policy to enforce the received CDMA2000 QoS attributes 242, action 250. The MS 202 installs the traffic flow template associated with the service instance using the RSVP (Resource Reservation Protocol, RFC 2205, published in September 1997) Resv message as defined in X.P0011.4(Annex B) for forward traffic flow mapping and treatment, all of which is herein enclosed by reference, action 252, and receives back confirmation 254. Data traffic 256 is then exchanged, where the PDSN 204 applies the appropriate traffic conditioning function based on the allowed QoS and provisioning of the interfaces.

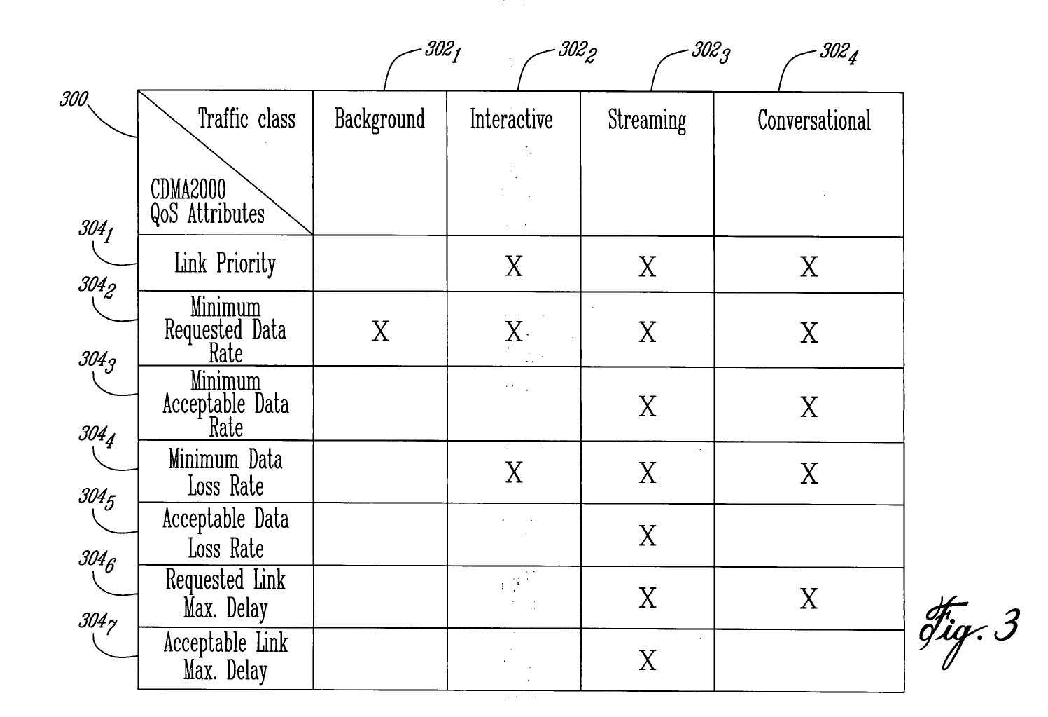

Reference is now made jointly to FIG. 2, previously described, and to FIG. 3, which is an exemplary mapping table 300 between QoS traffic classes 302 and CDMA2000 QoS attributes 304ⱼ according to the preferred embodiment of the invention. FIG. 3 provides a correspondence between the classes 302ᵢ to the attributes 304ⱼ, and may be used for the mapping 220 performed by the PDSN 204. When the PDSN 204 receives the message 213 with the QoS traffic classes 216, it needs to translate, or map, the received classes into CDMA2000 QoS attributes. For this purpose, the PDSN 204 may use the mapping table 300. For example, in the mapping table 300, the traffic class “conversational” 302₄ corresponds to the following CDMA2000 QoS attributes: the link priority attribute 304₁, the minimum requested data rate attribute 304₂, the minimum acceptable data rate attribute 304₃, the minimum data loss rate attribute 304₄, and the requested link maximum delay attribute 304₆.

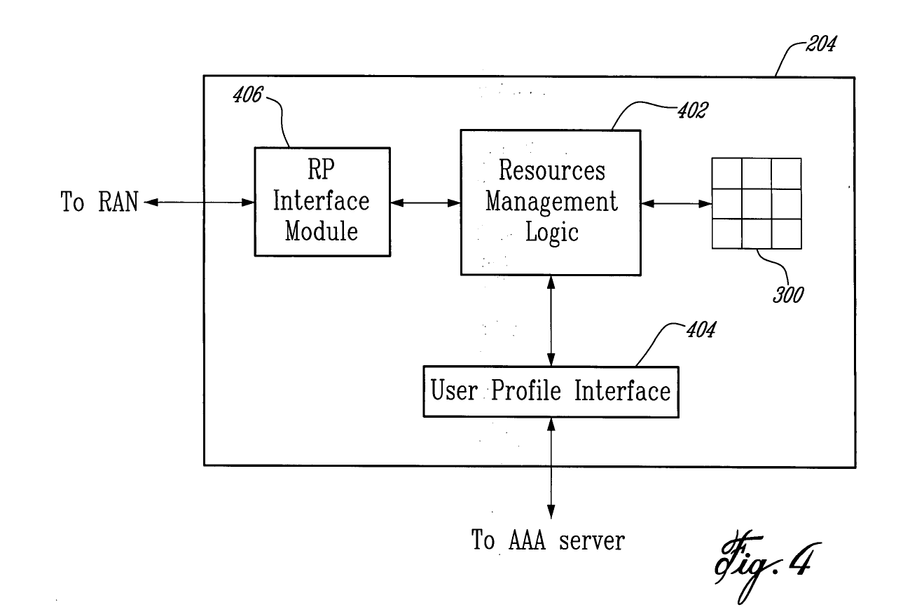

Reference is now made jointly to FIG. 2, previously described, and to FIG. 4, which is an exemplary high-level block diagram of the PDSN 204 implementing the preferred embodiment of the invention. The PDSN 204 comprises the mapping table 300, previously described, that maps the QoS traffic classes 302ᵢ to the CDMA2000 QoS attributes 304ⱼ according to the preferred embodiment of the invention. The PDSN 204 further comprises resources management logic 402 that may act as a processor for performing actions 220 and 240, better described in relation to FIG. 2. The PDSN 204 may also comprise a User Profile Interface 404 for interfacing with the AAA server 206, for example for performing action 213. Finally, the Resources Management Logic 402 connects with an RP Interface module 406 that may be the PDSN's communication interface with the RAN 206, and that may be used for performing actions 222, 226, 236, and 244.

Therefore, with the present invention it becomes possible to also use QoS traffic classes as a means for specifying QoS requirements in a CDMA2000 network, in a manner that is transparent to the user and the RAN.

Based upon the foregoing, it should now be apparent to those of ordinary skills in the art that the present invention provides an advantageous solution. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for insuring Quality of Service (QoS) for a data session in a CDMA2000 network, the method comprising the steps of:
a) receiving a message from an Authentication, Authorization, and Accounting (AAA) server, the message comprising a QoS traffic class relative to a subscriber;
b) mapping the QoS traffic class to at least one CDMA2000 QoS attribute; and
c) using the at least one CDMA2000 QoS attribute for establishing the data session for the subscriber.

2. The method of claim 1, wherein step c) comprises the steps of:
c.1) receiving a request for an auxiliary service instance having a requested CDMA2000 QoS attribute; and
c.2) determining whether or not the requested CDMA2000 QoS attribute for the auxiliary service instance is allowed using the at least one CDMA2000 QoS attribute.

3. The method of claim 2, further comprising the step of:
d) if the CDMA2000 QoS attribute is allowed, setting-up the auxiliary service instance with a QoS that corresponds to the requested CDMA2000 QoS attribute.

4. A Packet Data Service Node (PDSN) for use in a CDMA2000 network, the PDSN comprising:
a mapping table storing a correspondence between QoS traffic classes and CDMA2000 QoS attributes;
a User Profile Interface capable of receiving a message from an Authentication, Authorization, and Accounting (AAA) server, the message comprising a QoS traffic class relative to a subscriber; and
a Resources Management Logic that maps the QoS traffic class to at least one CDMA2000 QoS attribute using information from the mapping table, and that uses the at least one CDMA2000 QoS attribute for establishing a data session for a subscriber.

5. The PDSN of claim 4 further comprising:
a Radio access network Packet data (RP) Interface module capable of receiving a request for an auxiliary service instance having a requested CDMA2000 QoS attribute;
wherein the Resources Management Logic determines whether or not the requested CDMA2000 QoS attribute for the auxiliary service instance is allowed using the at least one CDMA2000 QoS attribute.

6. The method of claim 5, wherein if the CDMA2000 QoS attribute is allowed, the RP Interface module acts to set-up the auxiliary service instance with a QoS that corresponds to the requested CDMA2000 QoS attribute.
